(19) United States
(12) Patent Application Publication
(10) Pub. No.: US 2020/0236951 A1
(43) Pub. Date: Jul. 30, 2020

(54) BREAD-MAKING IMPROVER COMPRISING MICROORGANISMS

(71) Applicant: LESAFFRE ET COMPAGNIE, PARIS (FR)

(72) Inventors: François BLAREAU, MARCQ-EN-BAROEUL (FR); Pascal BONNARDEL, MARCQ EN BAROEUL (FR); Kathia Medaly ROMERO ZURITA, BIOLLET (FR)

(73) Assignee: LESAFFRE ET COMPAGNIE, PARIS (FR)

(21) Appl. No.: 16/652,739

(22) PCT Filed: Oct. 2, 2018
(86) PCT No.: PCT/EP2018/076772

§ 371 Date: Apr. 1, 2020

(30) Foreign Application Priority Data
Oct. 5, 2017 (FR) 1759325

(51) Int. Cl. A21D 8/04; A21D 10/00; A21D 2/22; A21D 2/18; A21D 2/02

(52) U.S. Cl. CPC A21D 8/045; A21D 8/047; A21D 10/005; A21D 2/02; A21D 2/22; A21D 8/042; A21D 2/185; A21D 10/007

(57) ABSTRACT

A bread-making improver including at least one ingredient routinely used as a bread-making improver and at least 10⁷ CFU per gram of microorganisms and having a pH of between 3.5 and 5 and preferably between 4 and 4.8. The improver can be obtained by dispersing the ingredient in a phase including at least 10⁷ CFU of microorganisms, the pH of which has been adjusted to the desired value by adding a salt having a buffer effect. The phase is preferably a leaven in liquid or pasty form or in the form of a block that can be crumbled. The improver can be kept at a temperature lower than 10° C. and preferably lower than 6° C. for several days while maintaining its stability.

The present invention relates to a bread improver comprising microorganisms and having a pH of between 3.5 and 5.

The use of bread improvers, in particular improvers with enzymatic activity or activities, has been known for a long time.

In particular, it is known practice to use such enzymatic improvers in powder form. Pulverulent enzymatic improvers have a certain number of drawbacks. They have a tendency to disperse in air and to be deposited everywhere in the bakery. This requires not only regular cleaning of the work area, but can also cause allergic reactions in users. This is because the enzymes consist of proteins and have well-known allergic properties. Furthermore, powders are difficult to meter in an automated manner.

These problems are only partially solved by the use of enzymatic improvers in the form of granules, pellets or tablets.

It has also been proposed to use liquid enzymatic improvers. These liquid improvers in fact have the advantage of not dispersing in the air and of thus limiting the risk of allergic reactions in those working in the area. Liquid improvers also enable automated metering, provided that said liquid improver is homogeneous at the time of metering. However, liquid improvers are usually formulated with liquid fatty ingredients or with polyols, or with hydrocolloids or with preservatives which are not permitted in certain bread-making formulas and/or in certain countries. Furthermore, the presence of fat is nowadays not always appreciated by consumers.

EP 1 729 586 in the name of the applicant proposes a solid improver with enzymatic activity having a composition specifically designed to allow the baker to prepare, in his bakery, a liquid improver by dispersing said solid improver in water.

However, it has been noted that the microbial composition and the appearance of the liquid improver as described in EP 1 729 586 degrade as the storage time increases, in particular when the storage is carried out at ambient temperature, but also at 4° C. This quite obviously represents a major drawback for the final user, since the improver as a result becomes unfit for consumption.

Consequently, there remains the need to provide users with an enzymatic bread improver, or a bread improver with enzymatic activity, which makes it possible to overcome the drawbacks mentioned above and which has increased stability during storage.

In seeking to overcome all of the drawbacks mentioned above, the inventors of the present invention have noted that an enzymatic bread improver comprising microorganisms can be stored at a temperature of less than 10° C. and preferably less than 6° C. for many days, or even weeks, without its appearance, its microbial composition and its functionalities changing.

Indeed, it has been noted that the presence of a sufficient amount of microorganisms in the liquid improver allows microbial stability of the latter for a long period that can reach several weeks.

It has also been noted that the desired microbial stability is increased when the enzymatic bread improver has a pH of between 3.5 and 5 and preferably of between 4 and 4.8.

### SUMMARY OF THE INVENTION

The present invention relates to a bread improver having a pH of between 3.5 and 5, and preferably of between 4 and 4.8, comprising at least one ingredient customarily used as a bread improver and at least 10⁷ CFU per gram of microorganisms.

The improver of the invention may be in liquid or pasty form or in the form of a block that can be crumbled. It can be obtained by the various mixing or dispersing techniques. By way of indication, when the improver of the invention is in liquid form, it can be prepared by dispersing said ingredient in an aqueous phase comprising at least 10⁷ CFU of microorganisms. In this case, the aqueous phase is preferably a liquid leaven, the pH of which has been adjusted to the desired value. This adjustment can be carried out by adding a salt having a buffer effect.

The improver of the invention can be stored at a temperature of less than 10° C. and preferably less than 6° C. for several days while retaining its stability.

### BRIEF DESCRIPTION OF THE FIGURES

FIG. 1 is a photo relating to the instability of composition A (control improver) showing the appearance of mold.

FIGS. 2 and 3 show bread baguettes obtained according to a conventional bread-making test using either the improver according to the invention or a powdered control improver comprising the same ingredients as the improver according to the invention.

FIG. 4 is a photo showing two graduated cylinders; one, the one on the left, comprises a control improver (composition A) and a water-insoluble emulsifier (E471), and the other comprises the improver according to the invention and the water-insoluble emulsifier (composition B).

### DETAILS OF THE INVENTION

The present invention thus relates to an enzymatic bread improver having a pH of between 3.5 and 5, comprising food ingredients customarily constituting a bread improver, and microorganisms.

The improver of the invention may be liquid or pasty or in the form of a block that can be crumbled. The term “block that can be crumbled” is intended to mean a product presented in the form of a block, such as a bread, that can be easily broken up with simple means or by simple pressure from the hand.

According to one preferential form of the invention, said microorganisms represent at least 10⁷ CFU per gram of the improver.

The improver of the invention has a pH of between 3.5 and 5 and preferably of between 4 and 4.8 and even more preferentially between 4.3 and 4.7.

The improver of the invention can be obtained by mixing or dispersing at least one ingredient customarily used as a bread improver in a phase comprising the microorganisms. This mixing or dispersing step is followed, if required, by adjustment of the pH to the desired value. This adjustment can be carried out by adding a salt having a buffer effect.

According to one preferred form of the invention, the bread improver can advantageously be obtained by dispersing at least one ingredient customarily used as an improver in a phase comprising at least 10⁷ CFU of microorganisms per gram.

Said microorganisms can be chosen from the group comprising:
bacteria which are usually included in leavens, and in particular bacteria of the Lactobacillus or Streptococcus or Leuconostoc genus, and preferably Lactobacillus brevis, Lactobacillus plantarum and Lactobacillus casei bacteria;
yeasts and in particular yeasts of the Saccharomyces genus, and preferably Saccharomyces cervisiae, Pichia, Torulaspora, Candida, Kazachstania, etc., yeasts.

The phase comprising the microorganisms can be chosen from the group comprising:
liquid or pasty leavens or leavens in the form of a block that can be crumbled, having a solids content of between 3 and 80%, obtained on any type of substrate, such as wheat or rye flour,
yeasts having a solids content of between 3 and 80%, such as liquid yeasts, cream yeasts and pressed yeasts, and
liquid bacteria.

These products are commercially available and can be prepared by techniques widely described and known to those skilled in the art.

Advantageously, the phase comprising the microorganisms is chosen from leavens. Indeed, these products also have the advantage of introducing into the finished products (baked bakery products) a leaven flavor that is highly sought after in certain applications.

According to one preferential form, the improver according to the invention is in liquid form and, in this case, the phase in which the ingredient customarily used as an improver is dispersed is chosen from liquid leavens having a solids content of between 3 and 80% by weight and preferably between 3 and 30%, comprising at least 10⁷ CFU of microorganisms consisting of lactic bacteria and yeasts.

According to this preferred form, the liquid bread improver of the invention can be obtained in various ways and preferentially by dispersing at least one food ingredient customarily used as a bread improver in a liquid leaven, followed, if required, by adjusting the pH to the desired value.

In general, the adjusting of the pH is carried out by adding at least one ingredient chosen from the group comprising acetates, lactates, citrates and calcareous algae (known under the name Lithothamnium calcareum), these salts being moreover used and permitted in common breadmaking. Other suitable ingredients are water-soluble edible salts belonging to the family of fumarates, malates, propionates, phosphates, carbonates used in certain countries (United States for example) or in special bread-making products (rye bread for example). It is recalled that sodium and potassium salts are generally more soluble than calcium salts. Edible salts are by definition all the salts permitted as additives in the European Union (European Parliament and Council Directive No. 95/2 EC) or in the United States of America (Code of Federal Regulation 21—Food and Drug).

Preferably, the bread improver contains calcium acetate and/or calcium lactate and/or trisodium citrate and/or calcareous algae. Very positive results, exhibiting in particular a high buffer effect, have been obtained with trisodium citrate and with calcareous algae.

The ingredients can be dispersed in the phase comprising the microorganisms individually or else in the form of a solid composition. In the latter case, the solid composition is denoted by “solid bread improver” and may be any solid bread improver known to those skilled in the art.

It goes without saying that the bread improver ingredients are chosen from ingredients suitable for breadmaking.

In the case where the improver contains ascorbates, the latter have a role both as buffer salts and oxidants of flours, and they can totally or partially replace ascorbic acid. According to the invention, the solid improver preferably contains ascorbic acid and/or ascorbates, in an amount expressed as ascorbic acid equivalent having the required oxidizing capacity. In the present description with the exception of the examples, and in the claims, the expression “ascorbic acid” encompasses any composition comprising ascorbic acid and/or ascorbates, having, as ascorbic acid equivalent, the oxidizing capacity of the doughs required in the formula, it being understood that the most preferred embodiments of the invention are carried out with ascorbic acid, in the strict sense, that is to say in the acid form.

According to one embodiment, the improver according to the invention comprises at least one enzyme chosen from the group of amylases, xylanases, glucose oxidases, amyloglucosidases, lipases, phospholipases, sulfhydryl oxidases, proteases and cellulases and any other enzymes used in breadmaking; preferably, it comprises a combination of said enzymes. Beneficially, the improver comprises at least one alpha-amylase chosen from the group of fungal and bacterial alpha-amylases or a combination of said alpha-amylases, in particular the improver can comprise an antistaling alpha-amylase, such as for example a maltogenic alpha-amylase. The improver may contain a combination of at least one alpha-amylase with at least one xylanase.

The enzyme or the enzyme mixture is present in a content of between 0.05 and 2% and preferably between 0.2 and 0.6% by weight of the improver.

Beneficially, the bread improver may additionally contain, in addition to the combination of alpha-amylase(s) above, an amount of phospholipase(s) having a technological effect similar to an addition of diacetyl tartaric esters of mono and diglycerides of fatty acids (E472e emulsifiers) carried out at a dose of between 0.05% and 0.30% by weight of the improver.

Beneficially, the bread improver contains from 0.1 to 5% by weight of ascorbic acid and preferably from 1 to 3%.

The bread improver may also comprise other food ingredients and in particular such food ingredients used in baking and especially those which have a bread improver effect. Examples of such a food ingredient are L-cysteine monohydrochloride and sodium chloride. Preferentially, the solid improver according to the invention will comprise all the oxidants of the dough, optionally all the reducing agents of the dough, all the enzymatic preparations required for the type of breadmaking envisioned, whether it involves the production, regardless of the process, of breads, Viennese pastries, brioches, and generally any fermented dough, plus all the usual emulsifiers (DATEM, monoglycerides, SSL, etc.).

It should also be noted that solid emulsifiers do not easily disperse in water, and form unstable liquids (separation rapidly into two phases: aqueous and fatty) and that, with the leaven, it is possible to carry out this dispersion and the latter is stable (see example 4).

The bread improver obtained by dispersing at least one food ingredient as described above in a phase comprising at least 10⁷ CFU of microorganisms can be stored at a temperature of less than 10° C. and preferably less than 6° C. for a period of greater than 8 weeks. It is clearly understood that, the lower the storage temperature, the longer can be the period of stability of the ingredients and of the bacterial composition of the liquid improver and, consequently, its appearance and its sanitary properties. Thus, if the storage is performed under refrigeration conditions (for example 4° C.), the improver can be stored for at least 14 weeks.

The improver, when it is in liquid form, may sediment over the course of its storage. To avoid this, it is possible to use stabilizers such as xanthan gum used at a content of between 0.1 and 1% and preferably between 0.2 and 0.4% by weight of the improver.

The invention also relates to the use of such a liquid improver in the preparation of a dough for a baked bakery product, such as for example a bread dough, a brioche dough or a Viennese pastry dough. Said dough typically comprises baker's yeast as fermentation agent.

Such a use of the bread improver makes it possible to reduce the number of ingredients that the baker must meter out separately. For example, the improver can contain an amount of sodium chloride such that, after addition of the corresponding improver to the dough, no additional separate addition of sodium chloride is any longer necessary.

The liquid improver is preferably incorporated into the dough in an amount corresponding to a baker's percentage of from 0.1 to 10% and preferably from 0.5 to 5%.

The invention also relates to a method for preparing a dough for a baked bakery product. This method according to the invention comprises dispersing, in an aqueous liquid phase comprising at least 10⁷ CFU of microorganisms, preferably a liquid leaven, at least one ingredient as described above, so as to obtain an enzymatic liquid improver, and incorporating an amount of said liquid improver into the dough.

The dough may be a bread dough, a brioche dough or a Viennese pastry dough, corresponding to the direct bakery technique or the deferred bakery technique using deep-freezing, refrigeration, prebaking, etc., techniques.

Preferably, the liquid improver according to the invention, and the methods according to the invention using this liquid improver, are improvers for French breads and methods for making French breads, that is to say breads that contain neither fat nor sugar that has been added.

The following examples illustrate the invention without limiting the scope thereof.

### Examples

1) Constitution of Compositions A (Control), B and C (Improvers According to the Invention)

Two liquid bread improvers were tested: a control improver not comprising microorganisms (composition A) and two improvers according to the invention (compositions B and C).

Table 1 below indicates the constitution of each composition used:

TABLE 1
constitution of the compositions used

| | Composition A | Composition B | Composition C |
|---|---|---|---|
| Aqueous phase | Water (95%) | LVBD (95%) | LVBD (97.5%) |
| Trisodium citrate | 2.5% | 2.5% | 0% |
| Ascorbic acid | 2.1% | 2.1% | 2.1% |
| Xylanases | 0.3% | 0.3% | 0.3% |
| Phospholipases | 0.07% | 0.07% | 0.07% |

LVBD is a liquid leaven on durum wheat having a solids content of 25%, a pH of less than 4 and TTA acidity of 12-25. LVBD comprises a flora representing more than 10⁷ CFU per gram and consisting of lactic bacteria and yeasts.

Composition B has a pH of 4.5, and composition C a pH of 3.6.

2) Method for Preparing Compositions A, B and C

Preparation of Compositions A, B and C:

The solid ingredients are weighed out and premixed. The premix is then added in proportion with slow stirring to mains water (5/15° C.) for composition A or to the LVBD 3000 leaven (4/8° C.) for compositions B and C.

Stirring continues for 10 minutes until complete dispersion and/or dissolution of the ingredients in the liquid phase.

The solution is then stored at 4° C.

3) Stability Tests:

a. Microbiological Stability

The microbiological stability was determined by monitoring the microorganism content of compositions A and B. The methods of analysis used are the methods customarily used and which are widely known to those skilled in the art. The results obtained are reproduced in table 2 below:

TABLE 2
results of the microbiological analysis of compositions A and B

| | | Method/ | T + 1 | T + 6 | T + 10 |
|---|---|---|---|---|---|
| Product | Microorganisms | standard | week | weeks | weeks |
| COMPOSITION B | Total flora | NF ISO4833-1 | 1.38 × 10⁹ | 8 × 10⁷ | 2.9 × 10⁸ |
| | Total coli | NF V08-015 | <100 | <100 | <100 |
| | E. coli | rapid Ecoli2 | <10 | <10 | <10 |
| | | BIORAD | | | |
| | Yeasts | NF V08-036 | 1.2 × 10⁶ | 4 × 10⁵ | 7 × 10⁵ |
| | Molds | NF V08-036 | <10 | <10 | <10 |
| | Lactobacilli | NF V08-030 | 1.16 × 10⁹ | 1.7 × 10⁸ | 2.4 × 10⁸ |
| | Staph | BKR23/10- | absence | | absence |
| | | 12/15 | | | |
| | Salmonellae | SMS of AES | absence | | absence |
| | Listeria | BKR23/02- | absence | | absence |
| | | 11/02 | | | |
| COMPOSITION A | Aerobic mesophilic | NF ISO 4833 | 3 | 2.1 × 10⁴ | 1.8 × 10⁶ |
| | bacteria | | | | |
| | Anaerobic mesophilic | NF V08-061 | 4 × 10⁵ | 6.9 × 10⁵ | 4.4 × 10⁷ |
| | bacteria | | | | |
| | Enterobacteria | ISO 21528-2 | 2.6 × 10⁴ | 3.6 × 10⁵ | 7.8 × 10⁵ |
| | Yeasts | ISO 21527-1 | 1 | 1.1 × 10⁵ | 5 × 10⁶ |
| | Molds | ISO 21527-1 | <100 | <10 000 | <10 000 |
| | Lactobacilli | NF EN 15787 | <10 | <10 | <10 |

On reading the table above, it is noted that composition B exhibits good microbiological stability over time, contrary to composition A.

b. Stability of the Appearance Over Time of Compositions A and B:

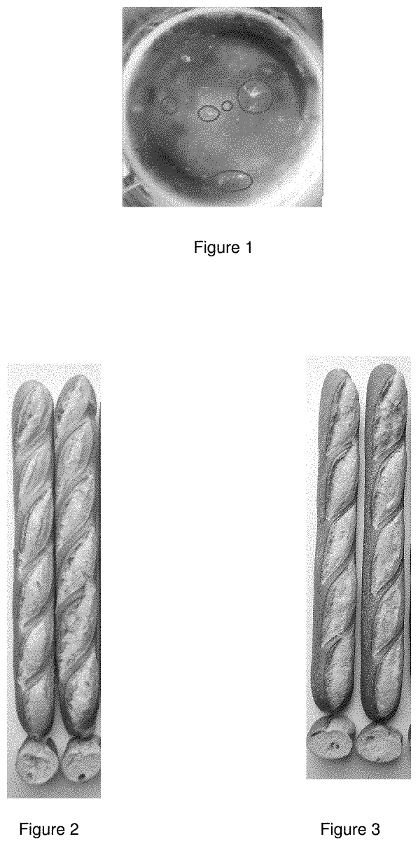

The results of the microbiological analyses indicated above are confirmed by examining the visual appearance of composition A. The following are in fact noted, after storage for 8 weeks at a temperature of 4° C.: a change in color of the composition and also the appearance of microbial proliferation (FIG. 1).

FIG. 1 shows that the control improver degrades very rapidly (after a few days of storage at 4° C.) due to the development of unwanted flora.

4) Functional Stability of the Bread-Making Ingredients Over Time:

Two bread-making tests were carried out using two improvers according to the invention (compositions B and C) and a control improver in powder form.

These tests are:
1. Test 1: makes it possible to compare an improver according to the invention (composition B) to an improver in powder form comprising the same ingredients as composition B.
2. Test 2: makes it possible to compare two improvers according to the invention, one (composition C) not comprising buffer salt (trisodium citrate) and having a pH of 3.6, compared to an improver buffered at a pH of 4.5.

The bread-making protocol implemented for these two tests is the following:

Composition (all the percentages are expressed in baker's % (100% relative to the flour):

Flour: 100%

Water: 62%

Yeast: 2%

Salt: 2%

Improver (powdered, composition B or C): 1%

### Procedure:

Kneading on Diosna machine (4 min at speed 1 and 8 min at speed 2)

Fermentation for 20 minutes

Division and rounding

Slackening for 20 minutes and shaping

Proofing 1 for 115 min at 27° C. and 75% humidity

Proofing 2 for 137 min at 27° C. and 57% humidity

Scarification: 5 cuts of the blade

Baking in a hearth oven for 15 min at 240° C.

### Results and Observations:

### Test 1:

This bread-making test shows that, beyond the bacteriological stability, composition B makes it possible to maintain the functionality of the bread-making ingredients over time.

Indeed, the improver according to the invention used at 1%, like a standard powdered bread improver, produces a result equivalent, in the bread-making test (bread baguette production), to this same powdered improver, this being at TO (FIG. 2) and after storage of said improver for 10 weeks at 4° C. (FIG. 3). FIGS. 2 and 3 do not show any difference in appearance between the bread baguettes prepared with a conventional powdered improver or with composition B after 10 weeks of storage.

Likewise, no difference in specific volume is observed during this bread-making test (table 3 below).

TABLE 3
variation in the specific volumes during bread-making tests

| | Bread-making at T0 | | Bread-making at T + 10 weeks | |
|---|---|---|---|---|
| | Improver in | Composition | Improver in | Composition |
| | powder form | B | powder form | B |
| Specific | 4.70 | 4.75 | 4.30 | 4.30 |
| volume | | | | |

### Test 2:

The following table (table 4 below) summarizes the specific volumes (SV) obtained with these two compositions after a standard proofing time (proofing 1) and after a proofing time with tolerance (proofing 2)

TABLE 4
variation in the specific volumes during test 2.

| Improver | SV with proofing 1 | SV with proofing 2 |
|---|---|---|
| Composition B | 8.38 | 10.92 |
| Composition C | 7.61 | 9.98 |

When the improver is not buffered (composition C, pH of 3.6), the dough has a tendency to become more tacky and its strength is more fragile. Furthermore, the cross section of the baguettes is less round and the specific volumes are smaller.

5) Stability of the Improver According to the Invention after Introduction of a Water-Insoluble Ingredient Such as an Emulsifier

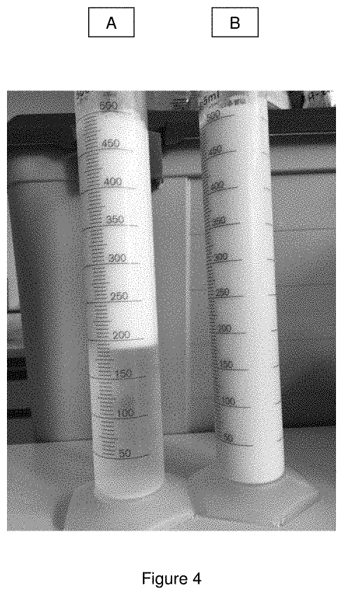

Contrary to the use of water, the use of a living leaven of the LVBD3000 type as used in composition B allows the dispersion of emulsifier such as E471 and the obtaining of a physically and microbiologically stable solution, as shown in FIG. 4, right-hand column.

1-13. (canceled)

14. A bread improver in liquid or pasty form or in the form of a block that can be crumbled, which is microbiologically stable at a temperature of less than or equal to 10° C., having a pH of between 3.5 and 5 and comprising:
a. at least 10⁷ CFU per gram of microorganisms, and
b. at least one food ingredient customarily constituting a bread improver.

15. The improver as claimed in claim 14, wherein the improver has a pH of between 4 and 4.8 and preferably between 4.3 and 4.7.

16. The bread improver as claimed in claim 14, wherein said microorganisms are chosen from the group comprising:
bacteria customarily used in leavens and in particular bacteria of the Lactobacillus or Streptococcus or Leuconostoc genus and preferably Lactobacillus brevis, Lactobacillus plantarum and Lactobacillus casei bacteria;
yeasts and in particular yeasts of the Saccharomyces genus and preferably Saccharomyces cervisiae, Pichia, Torulaspora, Candida, Kazachstania, etc., yeasts.

17. The improver as claimed in claim 14, wherein the microorganisms are introduced by a compound chosen from liquid or pasty leavens or leavens in the form of a block that can be crumbled, liquid yeasts, cream yeasts and pressed yeasts.

18. The bread improver as claimed in claim 17, wherein said leavens or said yeasts have a solids content of between 3 and 80% and preferably between 3 and 30%.

19. The bread improver as claimed in claim 14, wherein said food ingredients are selected from the group consisting of bread-making enzymes; salts such as acetates, fumarates, citrates, carbonates; marine algae, flour oxidants such as ascorbic acid and ascorbates.

20. The bread improver as claimed in claim 19, wherein the salts are chosen from trisodium citrates and calcareous algae.

21. The bread improver as claimed in claim 19, wherein the enzyme is selected from the group consisting of amylases, glucose oxidases, xylanases, amyloglucosidases, lipases, phospholipases, proteases, transglutaminases, cellulases, and mixtures thereof.

22. The bread improver as claimed in claim 21, wherein the enzyme or the enzyme mixture represents from 0.05 to 2% and preferably from 0.2 to 0.6% by weight of the improver.

23. The bread improver as claimed in claim 19, wherein the ascorbic acid is present in a content of between 0.1 and 5% and preferably between 1 and 3% of the improver.

24. The bread improver as claimed in claim 14, further comprising between 0.1 and 1% by weight and preferably 0.2 to 0.4% of a stabilizer gum such as xanthan gum.

25. A bread dough comprising the bread improver as claimed in claim 14.

26. A method of bread-making, comprising introducing the bread improver as claimed in claim 14 to a bread dough composition.

27. The method as claimed in claim 25, wherein the improver is introduced in a content of between 0.1 and 10% and preferably between 0.5 and 5% relative to 100% of flour.
